(19) United States
(12) Patent Application Publication
(10) Pub. No.: US 2012/0160277 A1
(43) Pub. Date: Jun. 28, 2012

(54) Liquid Processing Apparatus and Liquid Processing Method

(76) Inventor: Jiro HIGASHIJIMA, Koshi City (JP)

(21) Appl. No.: 13/334,539

(22) Filed: Dec. 22, 2011

(30) Foreign Application Priority Data
Dec. 28, 2010 (JP) 2010-293559

(51) Int. Cl. B08B 3/00

(52) U.S. Cl. 134/33; 134/157

(57) ABSTRACT

Disclosed are a liquid processing apparatus and a liquid processing method that can improve substitutability of an atmosphere in a processing chamber to prevent an atmosphere with, for example, a chemical liquid which is scattered during liquid-processing of a substrate from remaining in the processing chamber. In the liquid processing apparatus, an arm standby unit is installed adjacent to a processing chamber and an arm retreating from the processing chamber stands by in the arm standby unit. An elevating/descending cup peripheral case having a cylindrical shape is disposed around a cup in the processing chamber and when the cup peripheral case is disposed at an upper location, a region inside the cup peripheral case is isolated from the outside. An opening through which the arm passes is installed on the cup peripheral case.

### CROSS-REFERENCE TO RELATED APPLICATIONS

This application is based on and claims priority from Japanese Patent Application No. 2010-293559, filed on Dec. 28, 2010, with the Japanese Patent Office, the disclosure of which is incorporated herein in its entirety by reference.

### TECHNICAL FIELD

The present disclosure relates to a liquid processing apparatus and a liquid processing method that perform cleaning of a substrate or liquid-processing such as etching, plating, and developing of the substrate by supplying a processing liquid to the substrate while rotating the substrate in a horizontal state.

### BACKGROUND

As a conventional liquid processing apparatus that performs cleaning of a substrate such as a semiconductor wafer (hereinafter, referred to as a wafer) or liquid-processing such as etching, plating, and developing of a substrate by supplying a processing liquid to a top surface or a rear surface of the substrate while rotating the substrate in a horizontal state, various kinds of apparatuses have been known (see, for example, Japanese Patent Application Laid-Open No. 2009-94525). In Japanese Patent Application Laid-Open No. 2009-94525, disclosed is a single type liquid processing apparatus that rotates a substrate while maintaining a horizontal state by using a spin chuck, supplies a processing liquid to the surface of the substrate held and rotated by the spin chuck, and processes the substrate one by one. In the single type liquid processing apparatus, a technology has been known, which installs a fan filter unit (FFU) at an upper side of a processing chamber and sends gas such as N₂ gas (nitrogen gas) or clean air from the FFU into the processing chamber in a down-flow mode.

A configuration of a liquid processing apparatus in which an FFU is installed at an upper side of a processing chamber is described with reference to FIGS. 10 and 11. FIG. 10 is a lateral view schematically illustrating a configuration of a conventional liquid processing apparatus of the related art and FIG. 11 is a plan view of the conventional liquid processing apparatus shown in FIG. 10. As shown in FIGS. 10 and 11, the conventional liquid processing apparatus 200 of the related art includes a processing chamber (chamber) 210 in which a wafer W is received and liquid-processing of received wafer W is performed. As shown in FIGS. 10 and 11, a holding unit 220 that holds and rotates wafer W is installed in processing chamber 210, and a cup 230 is disposed around holding unit 220. In liquid processing apparatus 200 of the related art, a nozzle 240 that supplies a processing liquid from an upper side of cup 230 to wafer W held by holding unit 220 and an arm 241 that supports nozzle 240 are installed in processing chamber 210. An arm supporting portion 242 which is extended substantially vertically is installed at arm 241 to support arm 241. Arm supporting portion 242 is rotated by a driving mechanism (not shown) forwardly and reversely. By this, arm 241 is rotatable about arm supporting portion 242 forwardly and reversely, and as a result, arm 241 is rotatably moved about arm supporting portion 242 between an advance location (see a solid line in FIG. 11) where a processing liquid is supplied to a wafer W held by holding unit 220 and a retreat location (see an alternate long and two short dashes line in FIG. 11) where arm 241 is retreated from cup 230 (see an arrow in FIG. 11).

As shown in FIG. 10, a fan filter unit (FFU) 250 is installed at the upper side of processing chamber 210, and gas such as N₂ gas (nitrogen gas) or clean air is sent from FFU 250 into processing chamber 210 in a down-flow mode at all times. An exhaust unit 260 is installed at the bottom of processing chamber 210 and an atmosphere in processing chamber 210 is exhausted through exhaust unit 260. As such, the gas such as clean air is sent from FFU 250 into processing chamber 210 in the down-flow mode and exhausted through exhaust unit 260 to substitute the atmosphere in processing chamber 210.

### SUMMARY

An exemplary embodiment of the present disclosure provides a liquid processing apparatus, comprising: a processing chamber having a substrate holding unit configured to rotate a substrate while maintaining the substrate in a horizontal state and a cup disposed around the substrate holding unit; a nozzle configured to supply a processing liquid to the substrate held by the substrate holding unit; an arm configured to support the nozzle and be moved horizontally between an advance location advancing into the processing chamber and a retreat location retreating from the processing chamber; an arm standby unit installed adjacent to the processing chamber, in which the arm retreating from the processing chamber stands by; a cup peripheral case having a cylindrical shape and disposed around the cup in the processing chamber, and configured to be elevated/descended between an upper location and a lower location, and the cup peripheral case includes an opening through which the arm passes; and an exhaust unit installed inside the cup peripheral case and configured to exhaust an atmosphere in the processing chamber.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a plan view of a liquid processing system including a liquid processing apparatus according to an exemplary embodiment of the present disclosure when viewed from above.

FIG. 2 is a plan view schematically illustrating a configuration of the liquid processing apparatus according to the exemplary embodiment of the present disclosure.

FIG. 3 is a lateral view of the liquid processing apparatus shown in FIG. 2.

FIG. 4 is a longitudinal cross-sectional view illustrating the configuration of the liquid processing apparatus shown in FIG. 2 in detail in which a cup peripheral case is disposed at a lower location.

FIG. 5 is a longitudinal cross-sectional view illustrating the configuration of the liquid processing apparatus shown in FIG. 2 in detail in which the cup peripheral case is disposed at an upper location.

FIG. 6 is a perspective view illustrating a configuration of the cup peripheral case in the liquid processing apparatus shown in, for example, FIG. 4.

FIG. 7 is a lateral cross-sectional view illustrating a configuration of a cleaning unit of the cup peripheral case in the liquid processing apparatus shown in, for example, FIG. 4. FIG. 7A illustrates a case when the cup peripheral case is disposed at the upper location and FIG. 7B illustrates a case when the cup peripheral case is disposed at the lower location.

FIG. 8 is a view illustrating the flow of gas in a processing chamber when the cup peripheral case is disposed at the lower location.

FIG. 9 is a view illustrating the flow of gas in the processing chamber when the cup peripheral case is disposed at the upper location.

FIG. 10 is a lateral view schematically illustrating a configuration of a liquid processing apparatus of the related art.

FIG. 11 is a plan view of the liquid processing apparatus of the related art shown in FIG. 10.

### DETAILED DESCRIPTION

In the following detailed description, reference is made to the accompanying drawing, which form a part hereof. The illustrative embodiments described in the detailed description, drawing, and claims are not meant to be limiting. Other embodiments may be utilized, and other changes may be made, without departing from the spirit or scope of the subject matter presented here.

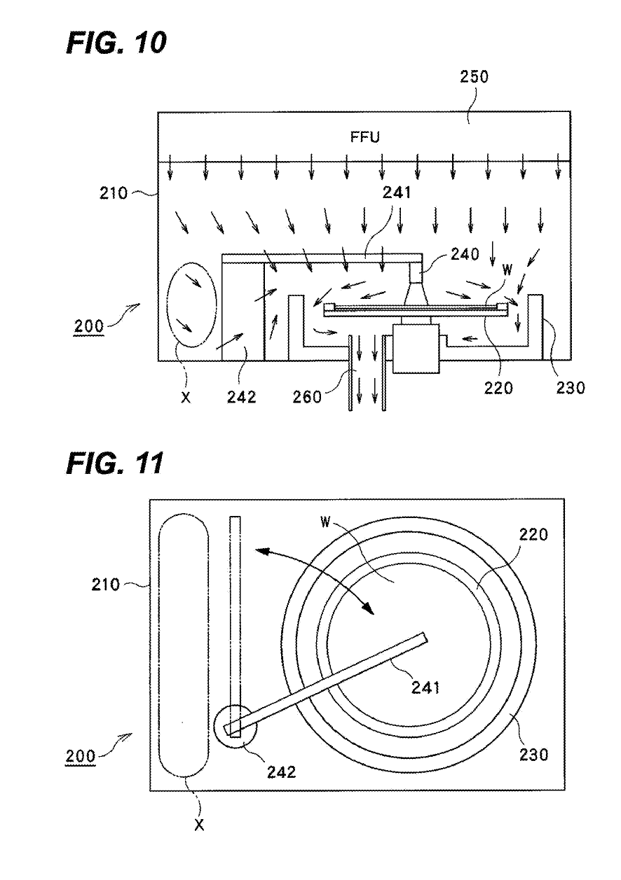

In conventional liquid processing apparatus 200 shown in FIGS. 10 and 11, since arm 241 that supports nozzle 240 and arm supporting portion 242 that supports arm 241 are installed in processing chamber 210, a space of a region outside cup 230 is increased and it is difficult to substitute the atmosphere in processing chamber 210 at the region outside cup 230. Specifically, in FIGS. 10 and 11, since a region represented by a reference mark X is positioned outside cup 230, the gas sent from FFU 250 into processing chamber 210 in the down-flow mode is likely to stay, such that the atmosphere may not be properly substituted in the region. As a result, in liquid processing apparatus 200 of the related art, when, for example, a chemical liquid is scattered in the region represented by reference mark X during liquid-processing of wafer W in processing chamber 210, an atmosphere with the chemical liquid remains in the corresponding region, and in a subsequent processing of wafer W, the atmosphere with the remaining chemical liquid may exert a negative influence, for example, contaminating wafer W. Specifically, for example, the chemical liquid is reattached to various dried objects including wafer W having been processed, which causes particles. An alkaline or acidic atmosphere in the remaining chemical liquid causes a chemical reaction to produce crystalline materials, which causes particles.

The present disclosure has been made in an effort to provide a liquid processing apparatus and a liquid processing method that can improve substitutability of an atmosphere in a processing chamber to prevent the atmosphere with, for example, a scattered chemical liquid during liquid-processing of a substrate from remaining in the processing chamber.

An exemplary embodiment of the present disclosure provides a liquid processing apparatus, comprising: a processing chamber having a substrate holding unit configured to rotate a substrate while maintaining the substrate in a horizontal state and a cup disposed around the substrate holding unit; a nozzle configured to supply a processing liquid to the substrate held by the substrate holding unit; an arm configured to support the nozzle and be moved horizontally between an advance location advancing into the processing chamber and a retreat location retreating from the processing chamber; an arm standby unit installed adjacent to the processing chamber, in which the arm retreating from the processing chamber stands by; a cup peripheral case having a cylindrical shape and disposed around the cup in the processing chamber, and configured to be elevated/descended between an upper location and a lower location, and the cup peripheral case includes an opening through which the arm passes; and an exhaust unit installed inside the cup peripheral case and configured to exhaust an atmosphere in the processing chamber.

Another exemplary embodiment of the present disclosure provides a liquid processing method, including: maintaining a substrate in a horizontal state by a substrate holding unit installed in a processing chamber; isolating a region inside a cup peripheral case disposed around the cup in the processing chamber from the outside by moving the cup peripheral case from a lower location to an upper location; advancing an arm that supports a nozzle from an arm standby unit installed adjacent to the processing chamber into the processing chamber; rotating the substrate by the substrate holding unit and supplying a processing liquid to the substrate held and rotated by the substrate holding unit by the nozzle of the arm which is advanced into the processing chamber; and exhausting an atmosphere in the processing chamber by an exhaust unit which is installed inside the cup peripheral case.

According to the liquid processing apparatus and the liquid processing method, it is possible to improve substitutability of an atmosphere in a processing chamber, particularly, inside the cup peripheral case since when the cup peripheral case is disposed at the upper location, the region inside the cup peripheral case is isolated from the outside by installing the arm standby unit in which the arm retreating from the processing chamber stands by, adjacent to the processing chamber and disposing the elevating/descending cup peripheral case around the cup in the processing chamber. Therefore, according to the liquid processing apparatus and the liquid processing method of the present disclosure, it is possible to improve substitutability of the atmosphere in the processing chamber to prevent the atmosphere with, for example, a chemical liquid which is scattered during liquid-processing of a substrate from remaining in the processing chamber.

The liquid processing apparatus of the present disclosure may further include a cleaning unit configured to clean the cup peripheral case.

In this case, the cleaning unit may include a storage part configured to store the cleaning liquid, and the cup peripheral case may be immersed in the cleaning liquid stored in the storage part when the cup peripheral case is disposed at the lower location.

In the liquid processing apparatus of the present disclosure, a wall which is extended vertically may be installed between the processing chamber and the arm standby unit and an opening through which the arm passes may be installed at the wall.

The liquid processing apparatus of the present disclosure may further include a guide member installed in the processing chamber and configured to guide a down-flow gas in the processing chamber from the inside of the cup peripheral case to the outside thereof near an upper end of the cup peripheral case when the cup peripheral case is disposed at the upper location.

According to the exemplary embodiments of the present disclosure, a liquid processing apparatus and a liquid processing method can improve substitutability of an atmosphere in a processing chamber to prevent the atmosphere with, for example, a scattered chemical liquid during liquid-processing of a substrate from remaining in the processing chamber.

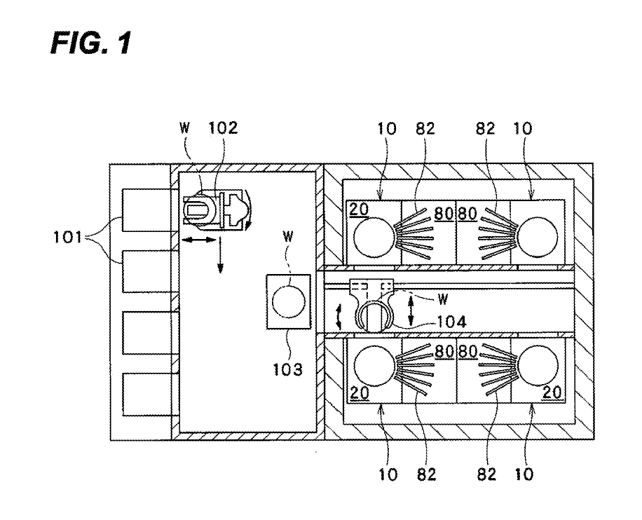

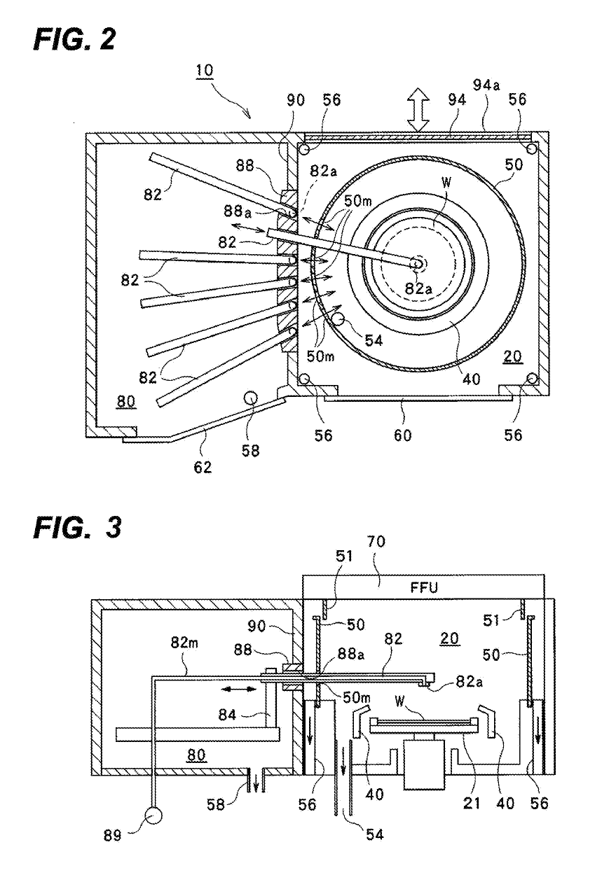

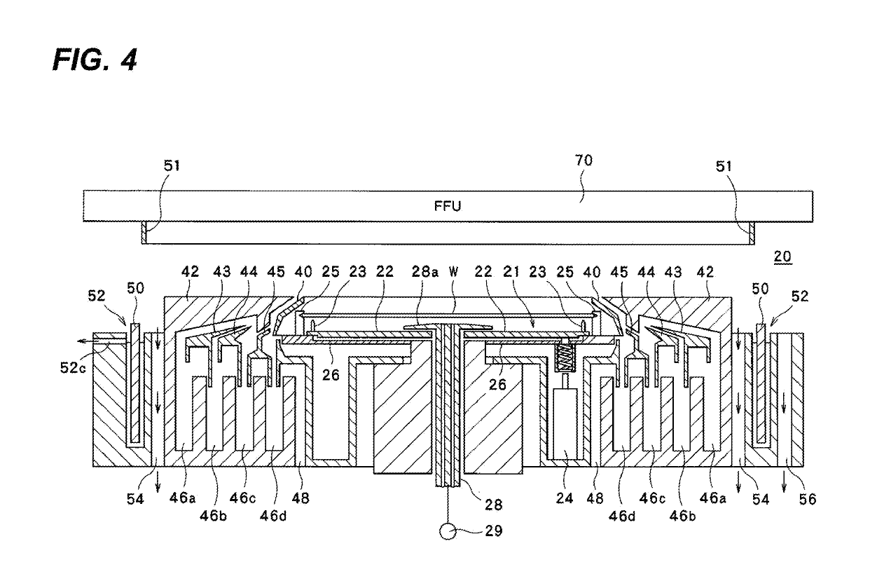

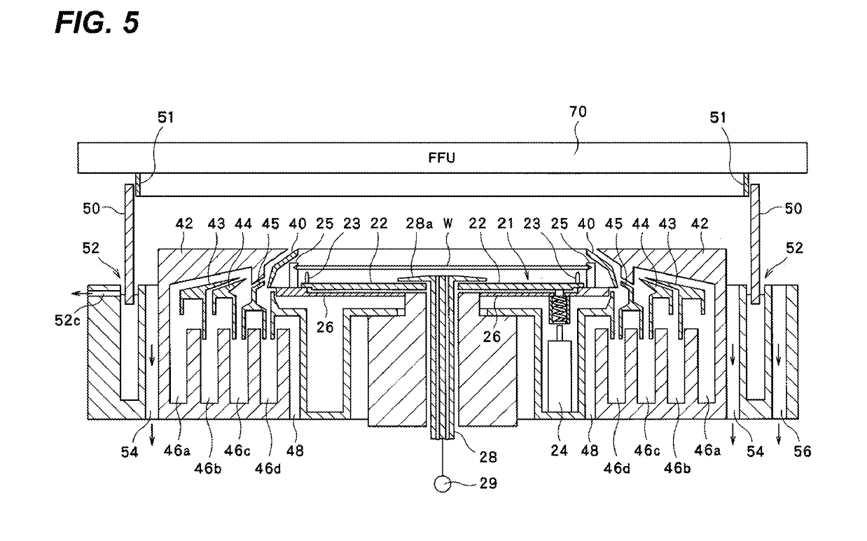

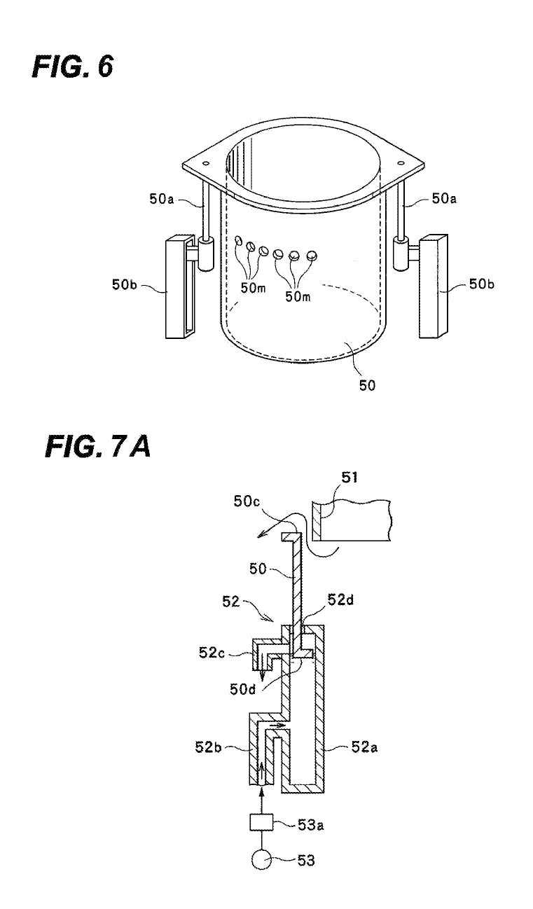

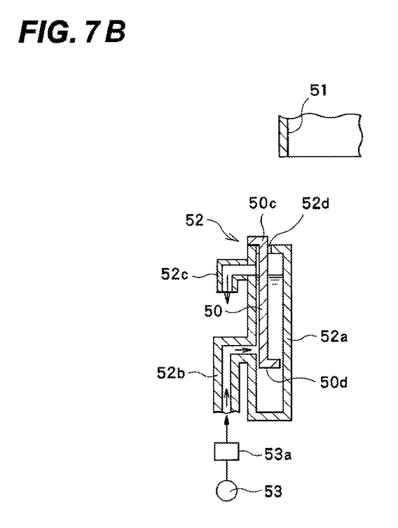

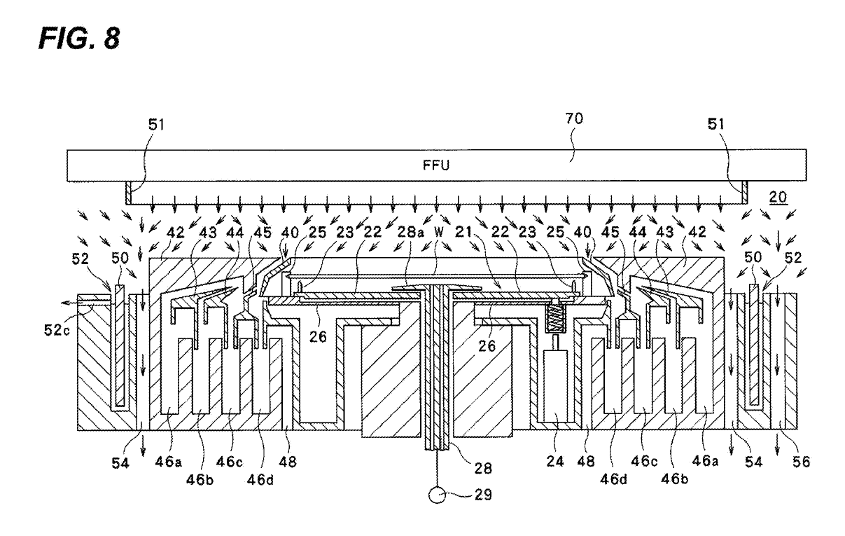

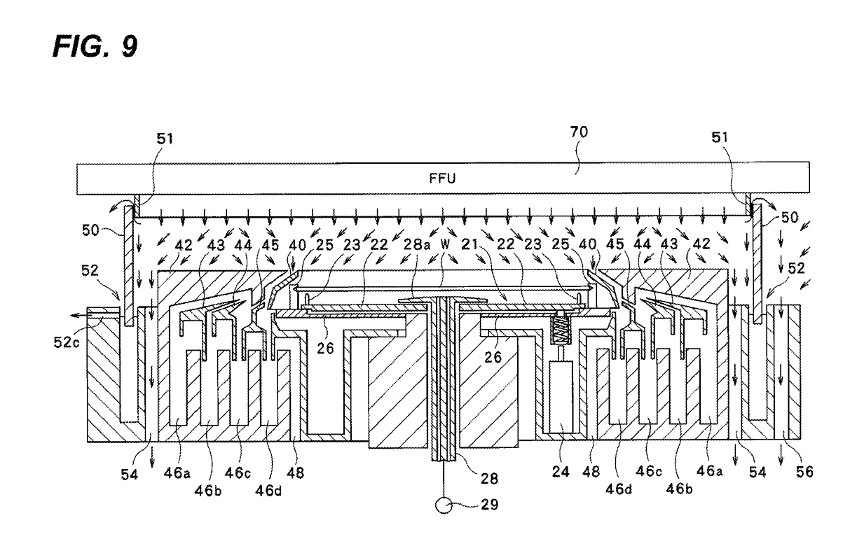

Hereinafter, an exemplary embodiment of the present disclosure will be described with reference to the accompanying drawings. FIGS. 1 to 9 are views illustrating a liquid processing apparatus according to the exemplary embodiment of the present disclosure. More specifically, FIG. 1 is a plan view of a liquid processing system including a liquid processing apparatus according to the exemplary embodiment of the present disclosure when viewed from above. FIG. 2 is a plan view schematically illustrating a configuration of the liquid processing apparatus according to the exemplary embodiment of the present disclosure and FIG. 3 is a lateral view schematically illustrating the liquid processing apparatus shown in FIG. 2. FIGS. 4 and 5 are longitudinal cross-sectional views illustrating the configuration of the liquid processing apparatus shown in FIG. 2 in detail. FIG. 6 is a perspective view illustrating a configuration of the cup peripheral case in the liquid processing apparatus shown in, for example, FIG. 4. FIG. 7 is a lateral cross-sectional view illustrating a configuration of a cleaning unit of the cup peripheral case in the liquid processing apparatus shown in, for example, FIG. 4. FIGS. 8 and 9 are views illustrating the flow of gas in a processing chamber when the cup peripheral case is disposed at the lower location and the upper location, respectively.

First, referring to FIG. 1, a liquid processing system including a liquid processing apparatus according to the exemplary embodiment of the present disclosure will be described. As shown in FIG. 1, the liquid processing system includes a placing table 101 that disposes a carrier thereon, in which the carrier receives a substrate such as a semiconductor wafer (hereinafter, referred to as a wafer W) as a target substrate from the outside, a transfer arm 102 that extracts wafer W received in the carrier, a rack unit 103 that holds wafer W extracted by transfer arm 102, and a transfer arm 104 that receives wafer W placed on rack unit 103 and transfers wafer W into a liquid processing apparatus 10. As shown in FIG. 1, in the liquid processing system, a plurality of liquid processing apparatuses 10 (four in exemplary embodiment shown in FIG. 1) are installed with a transfer path having transfer arm 104 interposed therebetween.

Hereinafter, a schematic configuration of liquid processing apparatus 10 according to the exemplary embodiment of the present disclosure will be described with reference to FIGS. 2 and 3.

As shown in FIGS. 2 and 3, liquid processing apparatus 10 according to the exemplary embodiment of the present disclosure includes a processing chamber (chamber) 20 in which wafer W is received and liquid-processing of received wafer W is performed. As shown in FIG. 3, a holding unit 21 that rotates wafer W in a horizontal state is installed in processing chamber 20 and a ring-shaped rotational cup 40 is disposed around holding unit 21. As shown in FIGS. 2 and 3, a cup peripheral case 50 having a cylindrical shape is disposed around rotational cup 40 in processing chamber 20. As described below, cup peripheral case 50 may be elevated/descended according to the processing status of wafer W. The configurations of holding unit 21, rotational cup 40, and cup peripheral case 50 will be described in detail below.

In liquid processing apparatus 10, a nozzle 82a that supplies a processing liquid from an upper side of wafer W to wafer W held by holding unit 21 and a nozzle arm 82 that supports nozzle 82a are installed. As shown in FIG. 2, a plurality of nozzle arms 82 (for example, six) are installed in a one liquid processing apparatus 10 and nozzle 82a is installed at a front end of each of nozzle arms 82. As shown in FIG. 3, an arm supporting unit 84 is installed at each of nozzle arms 82 and configured to be driven in a left and right direction in FIG. 3 by a driving mechanism (not shown). By this, each of nozzle arms 82 is rectilinearly moved in a horizontal direction between an advance location advancing into processing chamber 20 and a retreat location retreating from processing chamber 20 (see the arrow indicated on each of nozzle arms 82 in FIGS. 2 and 3). As shown in FIG. 3, a surface processing liquid supplying pipe 82m is installed in each of nozzle arms 82 and connected to a surface processing liquid supplying unit 89. A processing liquid is supplied from surface processing liquid supplying unit 89 to nozzle 82a of nozzle arm 82 through each of surface processing liquid supplying pipe 82m.

As shown in FIGS. 2 and 3, in liquid processing apparatus 10, an arm standby unit 80 is installed adjacent to processing chamber 20. Nozzle arm 82 that has retreated from processing chamber 20 stands by in arm standby unit 80. A wall 90 which is extended vertically is installed between arm standby unit 80 and processing chamber 20. Wall 90 includes an arm cleaning unit 88 provided with openings 88a through which each of nozzle arms 82 passes, respectively. Each of nozzle arms 82 is cleaned by arm cleaning unit 88.

As shown in FIG. 3, a fan filter unit (FFU) 70 is installed at an upper side of processing chamber 20 and gas such as N₂ gas (nitrogen gas) or clean air is sent from FFU 70 into processing chamber 20 in a down-flow mode. As shown in FIGS. 2 and 3, an exhaust unit 54 is installed inside cup peripheral case 50 on the bottom of processing chamber 20 and an atmosphere in processing chamber 20 is exhausted by exhaust unit 54. As such, the gas such as clean air is sent from FFU 70 into processing chamber 20 in the down-flow mode and exhausted by exhaust unit 54 to substitute the atmosphere in processing chamber 20.

As shown in FIGS. 2 and 3, an exhaust unit 56 is installed outside cup peripheral case 50 on the bottom of processing chamber 20 and an atmosphere outside cup peripheral case 50 in processing chamber 20 can be exhausted by exhaust unit 56. Specifically, exhaust unit 56 inhibits the atmosphere in arm standby unit 80 from traveling into cup peripheral case 50. Exhaust unit 56 inhibits the atmosphere in cup peripheral case 50 from traveling to arm standby unit 80.

As shown in FIGS. 2 and 3, an exhaust unit 58 is installed on the bottom of arm standby unit 80 and an atmosphere in arm standby unit 80 is exhausted by exhaust unit 58. Specifically, it is possible to expel particles generated from the driving mechanism (not shown) for driving each of nozzle arms 82 by exhaust unit 58.

As shown in FIG. 2, processing chamber 20 and arm standby unit 80 each have an entrance for access from the outside of liquid processing apparatus 10 and maintenance shutters 60 and 62 are installed at the entrances, respectively. Devices in processing chamber 20 and arm standby unit 80 can be maintained individually by installing maintenance shutters 60 and 62 at processing chamber 20 and arm standby unit 80, respectively. Devices in arm standby unit 80 can be maintained by opening shutter 62 even when wafer W is being processed in processing chamber 20.

As shown in FIG. 2, an opening 94a for carrying wafer W in processing chamber 20 and carrying out wafer W from processing chamber 20 by transfer arm 104 is provided at a side wall of processing chamber 20 at a transfer path side and a shutter 94 that opens and closes opening 94a is installed at opening 94a.

In liquid processing apparatus 10 shown in FIG. 2, a region inside cup peripheral case 50 in processing chamber 20 is under a slight positive pressure compared to a clean room, while a region outside cup peripheral case 50 in processing chamber 20 is under a slight negative pressure compared to the clean room. As a result, in processing chamber 20, the atmospheric pressure of the region inside cup peripheral case 50 is larger than the atmospheric pressure of the region outside cup peripheral case 50.

Next, the configuration of liquid processing apparatus 10 as shown in FIGS. 2 and 3 will be described in detail with reference to FIGS. 4 and 5.

As shown in FIGS. 4 and 5, holding unit 21 includes a disk-shaped holding plate 26 that supports wafer W and a disk-shaped lift pin plate 22 installed at an upper side of holding plate 26. Three lift pins 23 that support wafer W from below are installed with equal spacing in the circumferential direction on the top surface of lift pin plate 22. Only two lift pins 23 are shown in FIGS. 4 and 5. A piston mechanism 24 is installed at a lower side of lift pin plate 22 and elevates/descends lift pin plate 22. More specifically, when wafer W is put on lift pins 23 or extracted from lift pins 23 by transfer arm 104 (see FIG. 1), lift pin plate 22 is moved upward from a location shown in, for example, FIG. 4 by piston mechanism 24 and disposed above rotational cup 40. Meanwhile, when wafer W is subjected to liquid-processing in processing chamber 20, lift pin plate 22 is moved to the lower location shown in, for example, FIG. 4 by piston mechanism 24 and rotational cup 40 is disposed around wafer W.

Three holding members 25 that support wafer W at lateral sides are installed on holding plate 26 with equal spacing in the circumferential direction. Only two support members 25 are shown in FIGS. 4 and 5. Each of holding members 25 holds wafer W on lift pins 23 and makes wafer W slightly separated from lift pins 23 when lift pin plate 22 is moved from the upper location to the lower location as shown in FIGS. 4 and 5.

Through holes are formed at the centers of lift pin plate 22 and holding plate 26 respectively, and processing liquid supplying pipe 28 is installed to pass through the through holes. Processing liquid supplying pipe 28 supplies a processing liquid such as a chemical liquid or deionized water to a rear surface of wafer W held by holding members 25 of holing plate 26. Processing liquid supplying pipe 28 is elevated/descended by being interlocked with lift pin plate 22. A head part 28a is formed at an upper end of liquid processing liquid supplying pipe 28 to close the through hole of life pin plate 22. As shown in FIG. 4, a processing liquid supplying unit 29 is connected to processing liquid supplying pipe 28 and the processing liquid is supplied to processing liquid supplying pipe 28 by processing liquid supplying unit 29.

As shown in FIGS. 4 and 5, a ring-shaped rotational cup 40 is disposed around holding unit 21. Rotational cup 40 is attached to holding plate 26 and rotated integrally with holding plate 26. More specifically, rotation cup 40 is installed to surround wafer W supported by holding members 25 of holding plate 26 at the lateral sides and receives the processing liquid laterally scattered from wafer W during liquid-processing of wafer W.

A drain cup 42, a first guide cup 43, a second guide cup 44, and a third guide cup 45 are installed around rotational cup 40 in sequence from above. Drain cup 42 and each of guide cups 43, 44, and 45 are formed in a ring shape. In this case, drain cup 42 is fixed in processing chamber 20. Meanwhile, elevating/descending cylinders (not shown) are connected to guide cups 43, 44, and 45, respectively and guide cups 43, 44, and 45 may be independently elevated/descended by corresponding lifting cylinders.

As shown in FIGS. 4 and 5, a first processing liquid recovering tank 46a, a second processing liquid recovering tank 46b, a third processing liquid recovering tank 46c, and a fourth processing liquid recovering tank 46d are installed at lower sides of drain cup 42 or guide cups 43, 44, and 45, respectively. The processing liquid laterally scattered from wafer W during the liquid processing of wafer W is selectively sent to any one of four processing liquid recovering tanks 46a, 46b, 46c, and 46d according to vertical positions of guide cups 43, 44, and 45 based on the kind of processing liquids. Specifically, when all guide cups 43, 44, and 45 are disposed at an upper position (as shown in FIGS. 4 and 5), the processing liquid laterally scattered from wafer W is sent to fourth processing liquid recovering tank 46d. Meanwhile, when only third guide cup 45 is disposed at a lower position, the processing liquid laterally scattered from wafer W is sent to third processing liquid recovering tank 46c. When second and third guide cups 44 and 45 are disposed at the lower position, the processing liquid laterally scattered from wafer W is sent to second processing liquid recovering tank 46b. When all guide cups 43, 44, and 45 are disposed at the lower position, the processing liquid laterally scattered from wafer W is sent to first processing liquid recovering tank 46a.

As shown in FIGS. 4 and 5, an exhaust unit 48 is installed at inner side of fourth processing liquid recovering tank 46d. An atmosphere around wafer W is exhausted by exhaust unit 48 as the vertical positions of guide cups 43, 44, and 45 are predetermined positions.

In liquid processing apparatus 10 of the exemplary embodiment of the present disclosure, cup peripheral case 50 is installed around drain cup 42 or guide cups 43, 44, and 45 in processing chamber 20. Cup peripheral case 50 may be elevated/descended between a lower location as shown in FIG. 4 and an upper location as shown in FIG. 5. As shown in FIGS. 2 and 3, opening 50m through which nozzle arm 82 pass is installed on cup peripheral case 50. When cup peripheral case 50 is disposed at the upper location as shown in FIG. 5, the region inside cup peripheral case 50 is isolated from the outside.

The configuration of cup peripheral case 50 will be described in detail with reference to FIG. 6. FIG. 6 is a perspective view illustrating the configuration of cup peripheral case 50. As shown in FIG. 6, openings 50m through which nozzle arms 82 pass are installed at the side of cup peripheral case 50 depending on the number of nozzle arms 82 (for example, when the number of nozzle arms 82 is six, six openings 50m are provided). Support members 50a that support cup peripheral case 50 are connected to an upper portion of cup peripheral case 50 and driving mechanisms 50b that lifts and lowers corresponding support members 50a are installed at support members 50a. Cup peripheral case 50 supported by support members 50a is elevated/descended by elevating/descending support members 50a by driving mechanisms 50b.

As shown in FIGS. 4 and 5, guide member 51 is attached to FFU 70. Guide member 51 is disposed to be positioned at a narrow distance on the inward side from cup peripheral case 50 when cup peripheral case 50 is disposed at the upper location as shown in FIG. 5. In liquid processing apparatus 10 of the exemplary embodiment of the present disclosure, when cup peripheral case 50 is disposed at the upper location as shown in FIG. 5, the atmospheric pressure inside cup peripheral case 50 is larger than the atmospheric pressure outside cup peripheral case 50. Therefore, when cup peripheral case 50 is disposed at the upper location, a down-flow gas in processing chamber 20 generated by FFU 70 is guided from the inside of cup peripheral case 50 to the outside thereof near an upper end of cup peripheral case 50 by guide member 51, as shown in FIG. 9.

As shown in FIGS. 4 and 5, a cleaning unit 52 that cleans cup peripheral case 50 is installed in processing chamber 20. Cleaning unit 52 has a storage part 52a that stores a cleaning liquid such as deionized water and cup peripheral case 50 is immersed in the cleaning liquid stored in storage part 52a when cup peripheral case 50 is disposed at the lower location as shown in FIG. 4. Cleaning unit 52 cleans cup peripheral case 50 by immersing cup peripheral case 50 in the cleaning liquid stored in storage part 52a. As the cleaning liquid stored in storage part 52a, for example, deionized water having room temperature or more, preferably 40° C. or more, and more preferably 60° C. or more is used. When the temperature of the cleaning liquid stored in storage part 52a is high, cleaning effect on cup peripheral case 50 is improved.

The configuration of cleaning unit 52 will be described in detail with reference to FIG. 7. FIG. 7 is a lateral cross-sectional view illustrating the configuration of cleaning unit 52. Specifically, FIG. 7A shows when cup peripheral case 50 is disposed at the upper location and FIG. 7B shows when cup peripheral case 50 is disposed at the lower location.

As shown in FIG. 7, a cleaning liquid supplying pipe 52b is connected to storage part 52a that stores the cleaning liquid and the cleaning liquid is continuously sent to storage part 52a by cleaning liquid supplying pipe 52b. A cleaning liquid supplying unit 53 is connected to cleaning liquid supplying pipe 52b, and the cleaning liquid is supplied from cleaning liquid supplying unit 53 to cleaning liquid supplying pipe 52b. As shown in FIG. 7, a warming device 53a is installed at cleaning liquid supplying pipe 52b, and the cleaning liquid in cleaning liquid supplying pipe 52b is warmed by warming device 53a. A drain pipe 52c is installed at the side of storage part 52a and the cleaning liquid in storage part 52a is discharged by drain pipe 52c. That is, the cleaning liquid stored in storage part 52a remains clean at all times by continuously sending the cleaning liquid to storage part 52a by cleaning liquid supplying pipe 52b and discharging the cleaning liquid by cleaning liquid drain pipe 52c in storage part 52a. An upper opening 52d through which cup peripheral case 50 passes is provided on the top of storage part 52a.

When cup peripheral case 50 is disposed at the lower location as shown in

FIG. 7B, most of cup peripheral case 50 is immersed in the cleaning liquid stored in storage part 52a. Even when cup peripheral case 50 is disposed at the upper location as shown in FIG. 7A, a lower portion of cup peripheral case 50 is immersed in the cleaning liquid stored in storage part 52a. Therefore, when cup peripheral case 50 is disposed at the upper location, water seal is created between the cleaning liquid stored in storage part 52a and the lower portion of cup peripheral case 50 and a distance between the upper portion of cup peripheral case 50 and guide member 51 is small, such that the region inside cup peripheral case 50 can be isolated from the outside.

As shown in FIG. 7, a cover part 50c is installed at an upper end of cup peripheral case 50 and covers the cleaning liquid stored in storage part 52a when cup peripheral case 50 is disposed at the lower location as shown in FIG. 7B. Specifically, cover part 50c closes upper opening 52d of storage part 52a when cup peripheral case 50 is disposed at the lower location as shown in FIG. 7B. In cleaning unit 52, when the temperature of the cleaning liquid stored in storage part 52a is high (for example, 60° C. or more), the clean liquid stored in storage part 52a evaporates easily, and as a result, steam of the cleaning liquid is attached to, for example, wafer W when drying wafer W in processing chamber 20, which deteriorates drying efficiency. Even when the temperature of the cleaning liquid stored in storage part 52a is approximately 40° C., the cleaning liquid evaporates and as a result, steam of the cleaning liquid may be attached to, for example, wafer W when drying wafer W in processing chamber 20. By comparison, in liquid processing apparatus 10 according to the exemplary embodiment of the present disclosure, since cover part 50c is installed at the upper end of cup peripheral case 50, when cup peripheral case 50 is disposed at the lower location as shown in FIG. 7B, the cleaning liquid stored in storage part 52a evaporates and an atmosphere with the cleaning liquid can be prevented from traveling into processing chamber 20 or arm standby unit 80. In this case, even if the cleaning liquid stored in storage part 52a evaporates and the atmosphere with the cleaning liquid travels into processing chamber 20, since exhaust unit 54 is installed inside cup peripheral case 50 on the bottom of processing chamber 20 and exhaust unit 56 is installed outside the cup peripheral case 50, the atmosphere with the cleaning liquid is exhausted by exhaust units 54 and 56.

A cover part 50d is installed at a lower end of cup peripheral case 50 and covers the cleaning liquid stored in storage part 52a when cup peripheral case 50 is disposed at the upper location as shown in FIG. 7A. Since cover part 50d is installed at the lower end of cup peripheral case 50, even when cup peripheral case 50 is disposed at the upper location as shown in FIG. 7A, the cleaning liquid stored in storage part 52a evaporates and the atmosphere with the cleaning liquid may be prevented from traveling into processing chamber 20 or arm standby unit 80. When cup peripheral case 50 is disposed at the upper location as shown in FIG. 7A, the water seal is created between the cleaning liquid stored in storage part 52a and the lower portion of cup peripheral case 50 and as a result, the atmosphere inside cup peripheral case 50 can be inhibited from traveling outside cup peripheral case 50. Even when the water seal is not created, the atmosphere inside cup peripheral case 50 can be inhibited from traveling outside cup peripheral case 50 because exhaust unit 56 is installed.

When cup peripheral case 50 is disposed at the upper location as shown in FIG. 7A, guide member 51 attached to FFU 70 is positioned at a narrow gap on the inward side from the upper end of cup peripheral case 50. As described above, when cup peripheral case 50 is disposed at the upper location as shown in FIG. 7A, the atmospheric pressure inside cup peripheral case 50 is larger than the atmospheric pressure outside cup peripheral case 50. Therefore, as shown in FIG. 7A, a down-flow gas in processing chamber 20 generated by FFU 70 is guided from the inside of cup peripheral case 50 to the outside thereof near the upper end of cup peripheral case 50 by guide member 51.

As shown in FIGS. 4 and 5, in processing chamber 20, exhaust unit 54 that exhausts an atmosphere in processing chamber 20 is installed inside cleaning unit 52 and exhaust unit 56 that exhausts an atmosphere in processing chamber 20 is installed outside cleaning unit 52. By installing exhaust units 54 and 56, when cup peripheral case 50 is disposed at the lower location as shown in FIG. 4, all the atmosphere in processing chamber 20 can be exhausted by exhaust units 54 and 56 (see FIG. 8). Meanwhile, when cup peripheral case 50 is disposed at the upper location as shown in FIG. 5, since the region inside cup peripheral case 50 is isolated from the outside, the atmosphere inside cup peripheral case 50 can be exhausted by exhaust unit 54 and the atmosphere outside cup peripheral case 50 can be exhausted by exhaust unit 56 (see FIG. 9).

As described above, in the exemplary embodiment of the present disclosure, the plurality of nozzle arms 82 (for example, six) are installed in one liquid processing apparatus 10 and nozzles 82a are installed at front ends of nozzle arms 82, respectively. Specifically, nozzles 82a supply a first chemical liquid (for example, acidic chemical liquid), a second chemical liquid (for example, alkaline chemical liquid), deionized water, N₂ gas, isopropyl alcohol (IPA), mist of deionized water to the top surface of wafer W, respectively.

Next, an operation of liquid processing apparatus 10 having the configuration will be described.

First, lift pin plate 22 and processing liquid supplying pipe 28 in holding unit 21 are moved from the location shown in FIG. 4 upward and shutter 94 installed at opening 94a of processing chamber 20 is retreated from opening 94a to open opening 94a. Wafer W is transferred from the outside of liquid processing apparatus 10 into processing chamber 20 through opening 94a by transfer arm 104 and disposed on lift pins 23 of lift pin plate 22. Thereafter, transfer arm 104 retreats from processing chamber 20. In this case, cup peripheral case 50 is disposed at the lower location as shown in FIG. 4. Nozzle arms 82 are disposed at retreat positions of retreating from processing chamber 20. That is, each of nozzle arms 82 stands by in arm standby unit 80. The gas such as clean air is sent from FFU 70 into processing chamber 20 in the down-flow mode at all times and exhausted by exhaust unit 54, such that the atmosphere in processing chamber 20 is substituted with the gas from FFU 70.

Next, lift pin plate 22 and processing liquid supplying pipe 28 are moved downward to be disposed at the lower location shown in FIG. 4. In this case, holding members 25 installed at holding plate 26 hold wafer W on lift pins 23 and make wafer W slightly separated from lift pins 23.

Thereafter or during lowering lift pin plate 22, cup peripheral case 50 is disposed at the upper location as shown in FIG. 5 by moving cup peripheral case 50 upward by driving mechanisms 50b installed at cup peripheral case 50. After cup peripheral case 50 is moved at the upper location, one or the plurality of nozzle arms 82 among six nozzle arms 82 standing by in arm standby unit 80 advance into processing chamber 20 through opening 88a of arm cleaning unit 88 of wall 90 and opening 50m of cup peripheral case 50. In this case, nozzle arms 82 are moved rectilinearly.

Next, holding plate 26 and lift pin plate 22 in holding unit 21 are rotated. By this, wafer W held by holding members 25 of holding plate 26 is also rotated. While wafer W is being rotated, the processing liquid is supplied from nozzle 82a of nozzle arm 82 advancing into processing chamber 20 to the top surface of wafer W. In this case, a processing liquid such as a chemical liquid or deionized water is supplied from processing liquid supplying pipe 28 toward the bottom surface (rear surface) of wafer W. As such, the processing liquid is supplied to both the top surface and bottom surface of wafer W to perform liquid processing of wafer W. The processing liquid supplied to wafer W is selectively sent and recovered to any one of four processing liquid recovering tanks 46a, 46b, 46c, and 46d by positioning guide cups 43, 44, and 45 at the upper position or lower position separately based on the kind of the processing liquid.

Thereafter, when the liquid processing of wafer W is completed, nozzle arm 82 advancing into processing chamber 20 retreats from processing chamber 20 and stands by in arm standby unit 80. Cup peripheral case 50 is disposed at the lower location as shown in FIG. 4 by moving cup peripheral case 50 downward by driving mechanisms 50b installed at cup peripheral case 50.

Thereafter, lift pin plate 22 and processing liquid supplying pipe 28 in holding unit 21 are moved from the location shown in FIG. 4 upward. In this case, wafer W held by holding members 25 of holding plate 26 is released and transferred onto lift pins 23 of lift pin plate 22. Next, opening 94a is opened by retreating shutter 94 installed at opening 94a of processing chamber 20 from opening 94a. Transfer arm 104 advances into processing chamber through opening 94a from the outside of liquid processing apparatus 10 and wafer W onto lift pins 23 is transferred to transfer arm 104. Wafer W transferred to transfer arm 104 is transferred outside liquid processing apparatus 10. As such, a series of liquid processing of wafer W is completed.

As described above, according to liquid processing apparatus 10 of the exemplary embodiment, since arm standby unit 80 where nozzle arm 82 retreating from processing chamber 20 stands by is installed adjacent to processing chamber 20 and elevating/descending cup peripheral case 50 is disposed around rotational cup 40 in processing chamber 20, when cup peripheral case 50 is disposed at the upper location, the region inside cup peripheral case 50 is isolated from the outside (see FIG. 9), such that it is possible to enhance substitutability of the atmosphere inside processing chamber 20, particularly, inside cup peripheral case 50. Exhaust unit 54 that exhausts the atmosphere in processing chamber 20 is installed inside cup peripheral case 50. As a result, when cup peripheral case 50 is disposed at the lower location as shown in FIG. 4, all the atmosphere in processing chamber 20 may be exhausted (see FIG. 8). Meanwhile, when cup peripheral case 50 is disposed at the upper location as shown in FIG. 5, the region inside cup peripheral case 50 is isolated from the outside, and as a result, the atmosphere inside cup peripheral case 50 can be exhausted (see FIG. 9).

In this case, when, for example, the chemical liquid is scattered in the processing chamber during the liquid-processing of wafer W in the processing chamber, an atmosphere with the chemical liquid remains in the corresponding region and in subsequent processing of wafer W, the remaining atmosphere with the chemical liquid may exert a negative influence, for example, contaminating wafer W. Specifically, for example, the chemical liquid is reattached to various dried objects including wafer W having been processed, which causes particles. An alkaline or acidic atmosphere in the remaining chemical liquid causes a chemical reaction to produce crystalline materials, which causes particles. However, in liquid processing apparatus 10 of the exemplary embodiment of the present disclosure, since it is possible to enhance the substitutability of the atmosphere in processing chamber 20, particularly, inside cup peripheral case 50, it is possible to prevent the atmosphere with, for example, the chemical liquid which is scattered during the liquid processing of wafer W from remaining in processing chamber 20 or arm standby unit 80.

In liquid processing apparatus 10 of the exemplary embodiment of the present disclosure, as described above, cleaning unit 52 is installed to clean cup peripheral case 50. Therefore, cup peripheral case 50 can keep clean to prevent, for example, the chemical liquid which is scattered during the liquid processing of wafer W from remaining on cup peripheral case 50.

In liquid processing apparatus 10 of the exemplary embodiment of the present disclosure, cleaning unit 52 has storage part 52a for storing the cleaning liquid and when cup peripheral case 50 is disposed at the lower location, cup peripheral case 50 is immersed in the cleaning liquid stored in storage part 52a. Accordingly, cleaning unit 52 can clean cup peripheral case 50 by a simple method of immersing cup peripheral case 50 in the cleaning liquid stored in storage part 52a.

In liquid processing apparatus 10 of the exemplary embodiment of the present disclosure, as shown in FIGS. 2 and 3, wall 90 which is extended vertically is installed between processing chamber 20 and arm standby unit 80 and opening 88a through which nozzle arms 82 pass is installed at arm cleaning unit 88 of wall 90.

In liquid processing apparatus 10 of the exemplary embodiment of the present disclosure, as shown in FIG. 9, guide member 51 is installed in processing chamber 20 and when cup peripheral case 50 is disposed at the upper location, the down-flow gas in processing chamber 20 is guided from the inside of cup peripheral case 50 to the outside thereof near the upper end of cup peripheral case 50 by guide member 51. By installing guide member 51, the gas is inhibited from traveling from the outside of cup peripheral case 50 to the inside thereof near the upper end of cup peripheral case 50.

The liquid processing apparatus according to the exemplary embodiment is limited to the above-described aspect and various modifications may be made. For example, it is not necessary to supply the processing liquid to both the top surface and the bottom surface of wafer W by nozzle 82a of nozzle arm 82 advancing into processing chamber 20 and processing liquid supplying pipe 28, and the processing liquid may be supplied to only the top surface of wafer W by nozzle 82a of nozzle arm 82. The liquid processing apparatus according to the exemplary embodiment of the present disclosure may also be used in processing such as etching, plating, and developing in addition to the cleaning of the substrate.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

What is claimed is:

1. A liquid processing apparatus, comprising:
a processing chamber having a substrate holding unit configured to rotate a substrate while maintaining the substrate in a horizontal state and a cup disposed around the substrate holding unit;
a nozzle configured to supply a processing liquid to the substrate held by the substrate holding unit;
an arm configured to support the nozzle and be moved horizontally between an advance location advancing into the processing chamber and a retreat location retreating from the processing chamber;
an arm standby unit installed adjacent to the processing chamber, in which the arm retreating from the processing chamber stands by;
a cup peripheral case having a cylindrical shape and disposed around the cup in the processing chamber, and configured to be elevated/descended between an upper location and a lower location, and the cup peripheral case includes an opening through which the arm passes; and
an exhaust unit installed inside the cup peripheral case and configured to exhaust an atmosphere in the processing chamber.

2. The liquid processing apparatus of claim 1, further comprising:
a cleaning unit configured to clean the cup peripheral case.

3. The liquid processing apparatus of claim 2, wherein the cleaning unit includes a storage part configured to store a cleaning liquid, and the cup peripheral case is immersed in the cleaning liquid stored in the storage part when the cup peripheral case is disposed at the lower location.

4. The liquid processing apparatus of claim 1, wherein a wall which is extended vertically is installed between the processing chamber and the arm standby unit, and an opening through which the arm passes is installed at the wall.

5. The liquid processing apparatus of claim 1, further comprising:
a guide member installed in the processing chamber and configured to guide down-flow gas in the processing chamber from the inside of the cup peripheral case to the outside thereof near an upper end of the cup peripheral case when the cup peripheral case is disposed at the upper location.

6. A liquid processing method, comprising:
maintaining a substrate in a horizontal state by a substrate holding unit installed in a processing chamber;
isolating a region inside a cup peripheral case disposed around the cup in the processing chamber from the outside by moving the cup peripheral case from a lower location to an upper location;
advancing an arm that supports a nozzle from an arm standby unit installed adjacent to the processing chamber into the processing chamber;
rotating the substrate by the substrate holding unit and supplying a processing liquid to the substrate held and rotated by the substrate holding unit by the nozzle of the arm which is advanced into the processing chamber; and
exhausting an atmosphere in the processing chamber by an exhaust unit which is installed inside the cup peripheral case.
